(19) United States
(12) Patent Application Publication
(10) Pub. No.: US 2008/0073922 A1
(43) Pub. Date: Mar. 27, 2008

(54) Double Sided Rack Manipulator Jaw Actuator System

(75) Inventor: Todd Granger Holtz, Houston, TX (US)

Correspondence Address: DUANE MORRIS LLP, 3200 SOUTHWEST FREEWAY, SUITE 3150, HOUSTON, TX, 77027, US

(73) Assignee: OCEANEERING INTERNATIONAL, INC., Houston, TX (US)

(21) Appl. No.: 11/687,102

(22) Filed: Mar. 16, 2007

Related U.S. Application Data
(60) Provisional application No. 60/847,625, filed on Sep. 27, 2006.

(51) Int. Cl. B25J 15/08

(52) U.S. Cl. 294/88; 901/1; 901/15; 901/31; 901/37; 901/39; 294/106

(57) ABSTRACT

This invention is directed to a system for actuating manipulator jaws. This system employs a double sided rack, each side of which engages a pinion at a first end of a rotatably mounted lever. The second end of each lever comprises a jaw region. The present invention may be used with subsea manipulators mounted on remotely operated vehicles (“ROV's”).

### CROSS REFERENCE TO RELATED APPLICATION

This application claims the benefit of Provisional Application Ser. No. 60/847,625, filed on Sep. 27, 2006.

### FIELD OF THE INVENTION

This invention is directed to a system for actuating manipulator jaws. This system employs a double sided rack, each side of which engages a pinion at a first end of a rotatably mounted lever. The second end of each lever comprises a jaw region. The present invention may be used with subsea manipulators mounted on remotely operated vehicles (“ROV's”).

### BACKGROUND OF THE INVENTION

Prior art systems for actuating manipulator jaws comprise “C” shaped bushings, herein referred to as a “C bushing” that engages a T plate attached to a reciprocating piston. In such prior systems, as the piston extends, the contact between the C bushings and the t plate is steadily reduced. In such prior art systems, as the manipulator is used and the jaws are clamped around whatever is being pulled, moved, or picked up, this interface between the piston and link arms becomes the weak point of the assembly.

In prior art systems comprising C bushings and a T plate, the force of an uneven load on the jaws can cause the T-plate to be pried away from the piston shaft, causing the bolt that secures it to bend, thereby causing the C-bushings to become bound up on the T-plate. This can result in jamming of the jaws after several actuations. This can eventually lead to damage to the C bushings, the T plate and/or the associated bolt.

In the rack and pinion design used in preferred embodiments of this invention, the same forces are applied substantially evenly throughout the range of motion of the link arms and piston. Also, if the link arms are loaded unevenly because of shifted or heavy load, the force is transferred thru the link arm pinion pivot pin, the rack, and the other link arm pinion pivot pin. This is a preferable load distribution to that of the prior art systems described above.

### DESCRIPTION OF THE DRAWINGS

FIGS. 1a-1b are a side views of one preferred apparatus embodiment of the invention with the jaws closed and opened, respectively.

FIG. 2 is a side cross sectional view of a preferred embodiment of the piston housing and piston suitable for use in practicing the present invention.

FIG. 3 is a side view of a another preferred embodiment of the piston housing and piston used in the invention.

FIG. 4 is an isometric view of another apparatus embodiment of the invention.

FIG. 5 is an exploded isometric view of another apparatus embodiment of the invention.

### DESCRIPTION OF THE PREFERRED EMBODIMENTS

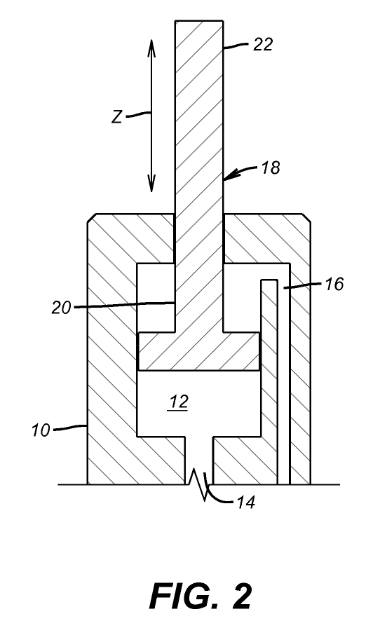

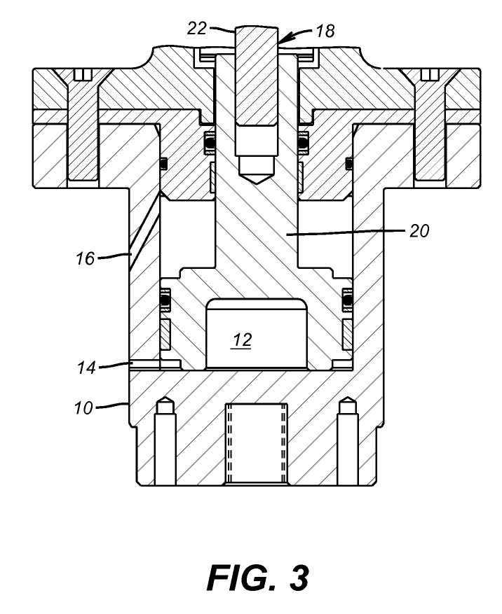

A first preferred apparatus embodiment of the invention is directed to a manipulator jaw and actuator system. It comprises a piston housing 10 comprising a piston chamber 12, a fluid inlet 14, and a fluid outlet 16, as shown in FIG. 2. In one preferred embodiment, the piston housing is cylindrical.

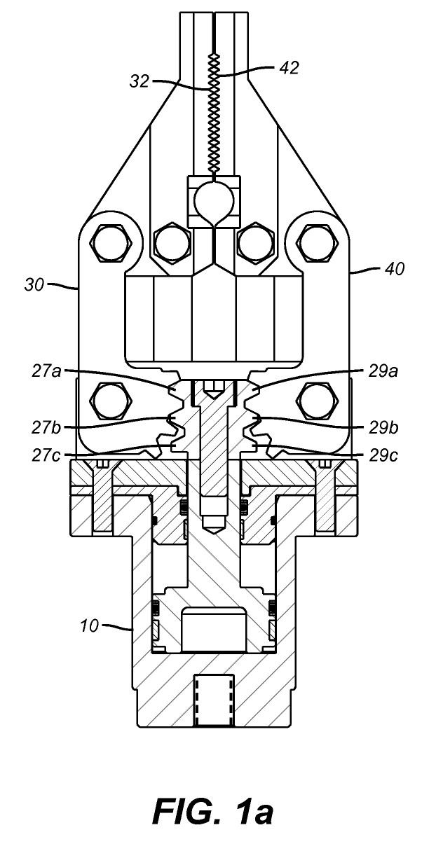

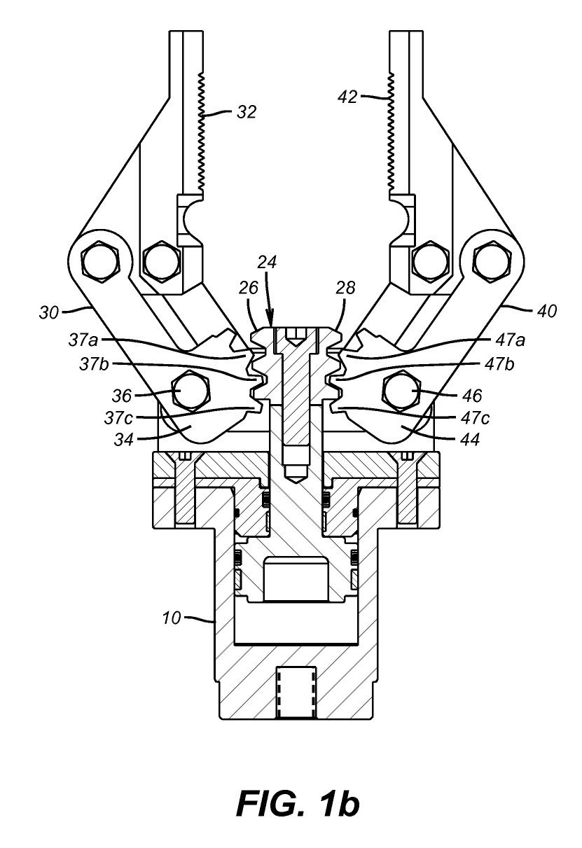

This apparatus embodiment further comprises a piston 18 having a lower region 20 slideably mounted in the piston chamber and an upper region 22 extending beyond the piston housing, as shown in FIG. 2, The piston is mounted in the housing such that the piston can reciprocate longitudinally from a final extended position, as shown in FIG. 1b, to a final retracted position, as shown in FIG. 1a, and from a final retracted position to a final extended position. The directions of this longitudinal reciprocation is denoted by arrow Z in FIG. 2.

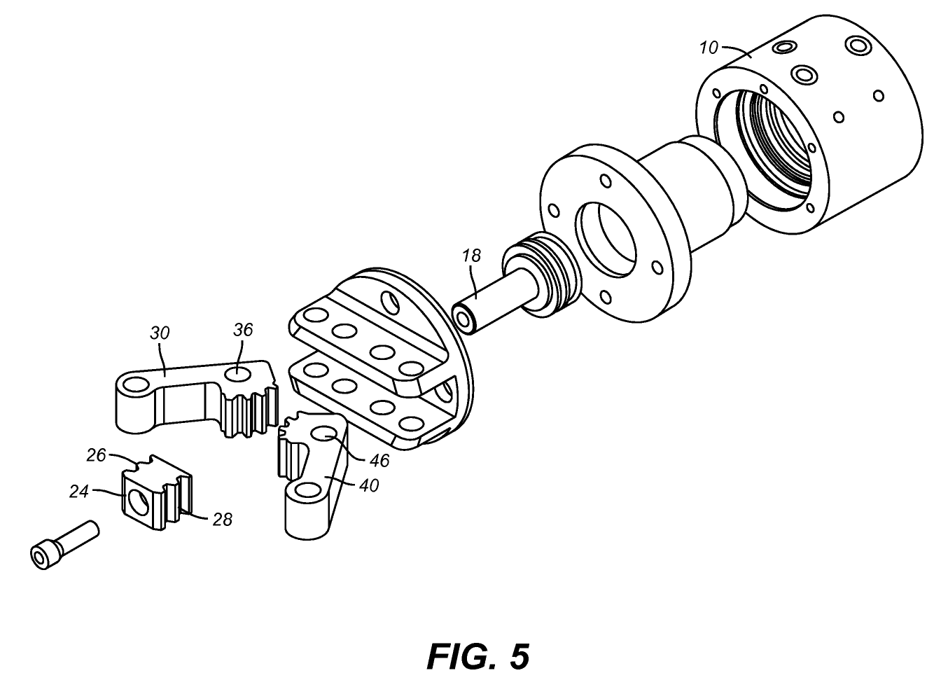

This apparatus embodiment further comprises a toothed rack 24 mounted on the upper region of said piston such that the rack moves with the piston, as shown in FIGS. 1a-1b. The rack has a first side 26 comprising three toothed fingers 27a-27c facing in a first direction, as shown in FIGS. 1a-1b, and 5. The rack has a second side 28 comprising three toothed fingers 29a-29c facing in a second direction opposite to the first direction, as shown in FIGS. 1a-1b, and 5.

This apparatus embodiment further comprises a first lever 30 comprising a first upper jaw 32 region and a first lower region 34 pivotally connected to the piston housing, as shown in FIGS. 1a-1b, and 5. The first lower region comprises a first pinion 36 having at least three toothed fingers 37a-c positioned to rotatably engage the first side of the toothed rack such that the first upper jaw region swings outward when the piston moves from a final retracted to a final extended position and swings inward when the piston moves from a final extended to a final retracted position, as shown in FIGS. 1a-1b, and 5.

This apparatus embodiment further comprises a second lever 40 comprising a second upper jaw 42 region and a second lower region 44 pivotally connected to the piston housing, as shown in FIGS. 1a-1b, and 5. The second lower region comprises a second pinion 46 having at least three toothed fingers 47a-c positioned to rotatably engage the second side of the toothed rack such that the second upper jaw region swings outward when the piston moves from a final retracted to a final extended position and swings inward when the piston moves from a final extended to a final retracted position, as shown in FIGS. 1a-1b, and 5.

In the preferred embodiment shown in FIGS. 1a-1b, the first and second upper jaws are toothed.

In another preferred embodiment, the first and second sides of the rack comprise two toothed fingers and the lower regions of the first and second levers each comprise two toothed fingers.

In another preferred apparatus embodiment, the rack is split down the middle into two components. The first component contains the first side of the rack described above and the second component contains the second side of the rack described above.

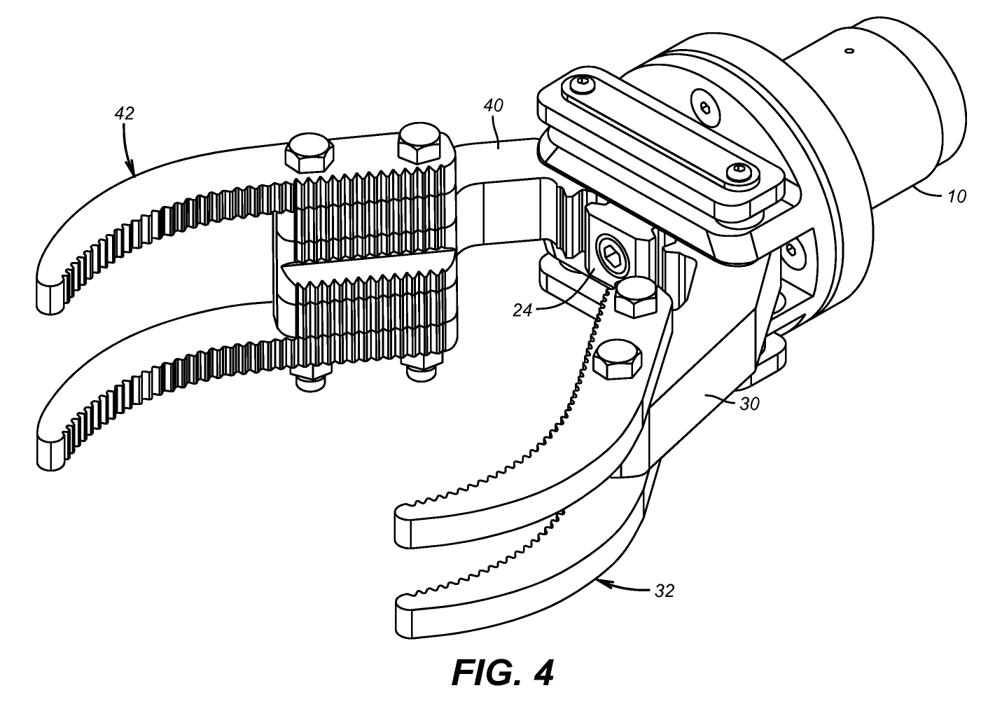

In another preferred embodiment, each jaw region comprises multiple toothed fingers, as shown in FIG. 4. In the preferred embodiment shown in FIG. 4, the multiple toothed fingers are curved.

In another preferred embodiment, the invention further comprises a manipulator arm attached to the piston housing. In a preferred embodiment, the manipulator arm is articulated. In another preferred embodiment, the invention comprises a remotely operated vehicle attached to the manipulator arm. In a preferred embodiment, the remotely operated vehicle comprises a hydraulic fluid reservoir and pumping system to control the position of the manipulator arm and piston.

It will be understood that various changes in size, shape, detail, parameters, and arrangements of the embodiments which have been described and illustrated above in order to explain the nature of this invention may be made by those skilled in the art without departing from the principle and scope of the invention.

What is claimed is:

1. A manipulator jaw and actuator system, comprising:
a. a piston housing comprising a piston chamber, a fluid inlet, and a fluid outlet;
b. a piston having a lower region slideably mounted in the piston chamber and an upper region extending beyond the piston housing, such that the piston can reciprocate longitudinally from a final extended position to a final retracted position and from a final retracted position to a final extended position;
c. a toothed rack mounted on the upper region of said piston such that the rack moves with the piston, said rack having a first side comprising three toothed fingers facing in a first direction, and a second side comprising three toothed fingers facing in a second direction opposite to the first direction;
d. a first lever comprising a first upper jaw region and a lower region pivotally connected to the piston housing, said lower region comprising a first pinion having at least three toothed fingers positioned to rotatably engage the first side of the toothed rack such that the first upper jaw region swings outward when the piston moves from a final retracted to a final extended position and swings inward when the piston moves from a final extended to a final retracted position; and
e. a second lever comprising a second upper jaw region and a lower region pivotally connected to the piston housing, said lower region comprising a second pinion having at least three toothed fingers positioned to rotatably engage the second side of the toothed rack such that the second upper jaw region swings outward when the piston moves from a final retracted to a final extended position and swings inward when the piston moves from a final extended to a final retracted position.

2. The manipulator jaw and actuator system of claim 1, wherein the piston housing is cylindrical.

3. The manipulator jaw and actuator system of claim 1, wherein the first and second upper jaw regions each comprise at least two fingers.

4. The manipulator jaw and actuator system of claim 3, wherein the multiple fingers are toothed.

5. The manipulator jaw and actuator system of claim 4, wherein the multiple fingers are curved.

6. The manipulator jaw and actuator system of claim 1, further comprising a manipulator arm attached to the piston housing.

7. The manipulator jaw and actuator system of claim 6, wherein the manipulator arm is articulated.

8. The manipulator jaw and actuator system of claim 6, further comprising a remotely operated vehicle attached to the manipulator arm.

9. A manipulator jaw and actuator system, comprising:
a. a piston housing comprising a piston chamber, a fluid inlet, and a fluid outlet;
b. a piston having a lower region slideably mounted in the piston chamber and an upper region extending beyond the piston housing, such that the piston can reciprocate longitudinally from a final extended position to a final retracted position and from a final retracted position to a final extended position;
c. a toothed rack mounted on the upper region of said piston such that the rack moves with the piston, said rack having a first side comprising two toothed fingers facing in a first direction, and a second side comprising two toothed fingers facing in a second direction opposite to the first direction;
d. a first lever comprising a first upper jaw region and a lower region pivotally connected to the piston housing, said lower region comprising a first pinion having at least two toothed fingers positioned to rotatably engage the first side of the toothed rack such that the first upper jaw region swings outward when the piston moves from a final retracted to a final extended position and swings inward when the piston moves from a final extended to a final retracted position; and
e. a second lever comprising a second upper jaw region and a lower region pivotally connected to the piston housing, said lower region comprising a second pinion having at least two toothed fingers positioned to rotatably engage the second side of the toothed rack such that the second upper jaw region swings outward when the piston moves from a final retracted to a final extended position and swings inward when the piston moves from a final extended to a final retracted position.

10. The manipulator jaw and actuator system of claim 9, wherein the piston housing is cylindrical.

11. The manipulator jaw and actuator system of claim 9, wherein the first and second upper jaw regions each comprise at least two fingers.

12. The manipulator jaw and actuator system of claim 11, wherein the multiple fingers are toothed.

13. The manipulator jaw and actuator system of claim 12, wherein the multiple fingers are curved.

14. The manipulator jaw and actuator system of claim 9, further comprising a manipulator arm attached to the piston housing.

15. The manipulator jaw and actuator system of claim 14, wherein the manipulator arm is articulated.

16. The manipulator jaw and actuator system of claim 14, further comprising a remotely operated vehicle attached to the manipulator arm.

17. A manipulator jaw and actuator system, comprising:
a. a piston housing comprising a piston chamber, a fluid inlet, and a fluid outlet;
b. a piston having a lower region slideably mounted in the piston chamber and an upper region extending beyond the piston housing, such that the piston can reciprocate longitudinally from a final extended position to a final retracted position and from a final retracted position to a final extended position;
c. a toothed rack mounted on the upper region of said piston such that the rack moves with the piston, said rack having a first side comprising two toothed fingers facing in a first direction, and a second side comprising two toothed fingers facing in a second direction opposite to the first direction;
d. a first lever comprising a first toothed upper jaw region and a lower region pivotally connected to the piston housing, said lower region comprising a first pinion having at least two toothed fingers positioned to rotatably engage the first side of the toothed rack such that the first upper jaw region swings outward when the piston moves from a final retracted to a final extended position and swings inward when the piston moves from a final extended to a final retracted position; and
e. a second lever comprising a second toothed upper jaw region and a lower region pivotally connected to the piston housing, said lower region comprising a second pinion having at least two toothed fingers positioned to rotatably engage the second side of the toothed rack such that the second upper jaw region swings outward when the piston moves from a final retracted to a final extended position and swings inward when the piston moves from a final extended to a final retracted position.

18. The manipulator jaw and actuator system of claim 17, wherein the first and second upper jaw regions each comprise at least two fingers.

19. The manipulator jaw and actuator system of claim 17, further comprising a manipulator arm attached to the piston housing.

20. The manipulator jaw and actuator system of claim 19, further comprising a remotely operated vehicle attached to the manipulator arm.
